(19) United States
(12) Patent Application Publication
(10) Pub. No.: US 2021/0261443 A1
(43) Pub. Date: Aug. 26, 2021

(54) PHOTOCATALYSIS AND DEVICE IMPLEMENTING SAME

(71) Applicants: CRISTIAN PREDESCU, BUCHAREST (RO); RUXANDRA VIDU, CITRUS HEIGHTS, CA (US); ECATERINA MATEI, BUCHAREST (RO); ANDRA MIHAELA PREDESCU, BUCHAREST (RO); MIRELA GABRIELA SOHACIU, BUCHAREST (RO); ANDREI CONSTANTIN BERBECARU, BUCHAREST (RO); GRIGORE VLAD, BISTRITA (RO)

(72) Inventors: CRISTIAN PREDESCU, BUCHAREST (RO); RUXANDRA VIDU, CITRUS HEIGHTS, CA (US); ECATERINA MATEI, BUCHAREST (RO); ANDRA MIHAELA PREDESCU, BUCHAREST (RO); MIRELA GABRIELA SOHACIU, BUCHAREST (RO); ANDREI CONSTANTIN BERBECARU, BUCHAREST (RO); GRIGORE VLAD, BISTRITA (RO)

(73) Assignee: POLITEHNICA UNIVERSITY OF BUCHAREST, BUCHAREST (RO)

(21) Appl. No.: 16/795,611

(22) Filed: Feb. 20, 2020

(51) Int. Cl. C02F 1/32; B01J 35/00

(52) U.S. Cl. CPC C02F 1/32; B01J 35/004; C02F 2201/328; B01D 2255/802; C02F 2201/3227

(57) ABSTRACT

A method and apparatus for photodegradation of pollutants using a modular baffled wastewater purification tank. Baffle surfaces are lined with a photocatalyst film and arrange in such a way to provide liquid turbulence and increased time for the photodegradation processes to occur. For certain embodiments, after water treatment, the baffle walls may be washed, regenerated, and re-introduced in the water treatment tank. The water treatment tank includes a series of UV lamps placed on the top of the photocatalytic chamber. Because of the modular design of the baffled purification system, the water treatment and the change of baffle pads can take place singly or simultaneously.

### FIELD OF THE INVENTION

The present invention relates to a process providing a photocatalytic treatment of water in a baffled wastewater purification tank. Specifically, the invention relates to a method for controlling the fluid flow using photocatalytic baffles, resulting in improved surface area for the photocatalytic reaction photon efficiency. Photocatalytic baffles are pads coated with a photocatalytic material or pads that have attached a photocatalytic film. In both cases, the surface of the photocatalytic baffles can be regenerated or replaced. The present invention also includes an improved photoreactor design which allows controlled circulation of the fluid under illumination, in which the pollutants present in water constantly move towards and attached to the deflecting baffle surface where the reaction takes place. The method of the present invention further allows the calculation of the time required to increase photocatalytic efficiency under conditions of continuous illumination for certain pollutants. The present invention is useful in the removal of organic contaminants from liquid phases, including aqueous and organic liquids, gas phases, and in the purification of pharmaceutical and industrial waste waters.

### BACKGROUND OF THE INVENTION

The removal of organic contaminants from water is currently performed by the use of adsorptive filters, heterogeneous photocatalysis, chemical and UV assisted oxidation, etc. In the photocatalysis systems for water treatment, various metal oxides semiconductors such as TiO₂, ZnO, SnO₂ and CeO₂ are used, which are capable of generating a hole in the valance band suitable for oxidizing the water to OH. This method comprises adding a metal oxide semiconductor material to an aqueous solution containing contaminants and exposing the solution to a light source of wavelengths between 300 to 700 nm. The photocatalytic properties of the catalyst are improved by increasing the available active sites on the metal oxide. It has been shown that powders improve the efficiencies by increasing the surface area to volume ratio, which minimizes the amount of material not exposed to the excitation source and reaction environment. The next step past using powders is using nanoparticles, which can increase the surface area by a factor of six. The photocatalysis process is part of the advanced oxidation process, which plays an important role in the degradation of organic pollutants by mineralizing them to CO₂ and H₂O in the presence of a catalyst with ultraviolet light irradiation. During this process, on the surface of the catalyst, there are two simultaneous processes. The first process is oxidation, during which the holes react with water molecules producing hydroxyl radicals, followed by the reduction of oxygen by electron-generating superoxide anion radicals.

Organic dyes present in wastewater effluents have a great impact on the environment. The industrial activities, which have been caused these problems, are produced by textiles, cosmetics, food, and paint. It has been reported that annually from the textile industry worldwide a huge quantity of dyes is produced, which are discharged into wastewater. Several methods are used to eliminate these organic pollutants from wastewater, including precipitation, sedimentation, membranes, and ion exchange. The common disadvantages of these methods include long times and high cost, and instead of eliminating the chemicals, there is transfer from the wastewater into solid waste. For this reason, one of the major challenges in the field of water remediation is photocatalysis, defined to be a green technology by respecting the environment.

When light shine on a semiconductor, it absorbs light with energy greater than that of the bandgap, and a photon will excite an electron from the valence band to the conduction band, thereby generating a hole in the valence band. The electron-hole pair diffuse to the surface of the semiconductors, two possible reactions may occur: 1) the photoexcited electron react with the reducible adsorbates, and/or 2) the hole reacts with the oxidizable adsorbates. These reactions are at the base of a wide range of applications in the environmental and pollution chemistry.

An improved photocatalytic method and a photoreactor design was presented by Sczechowski et al. in U.S. Pat. No. 5,439,652 (1995) in which the photoreactive material is exposed to controlled periodic illumination. Their invention was based on the discovery that a controlled periodic illumination of a photocatalyst increases the efficiency of the photo-oxidative reaction.

The most attractive catalyst is titanium dioxide (TiO₂) due to its unique proprieties that include stability, low toxicity, and high efficiency for the degradation of organic dye. The efficiency of the TiO₂ depends on the crystal structure, specific surface area, and porosity. Taking into account the difficulty of separating and recovering the particles from the wastewater at the end of the photocatalytic process, an alternative is to obtain nanostructures of TiO₂ on various substrates such as glass, graphite, metallic materials. The direct synthesis of TiO₂ nanostructures on Ti foil substrate may combine the advantages of nanostructured material, as well as provide unique electronic characteristics of nanosize TiO₂ that effectively renders electron transport and light scattering.

Environmental scientists are very concerned with the occurrence and the elimination of specific organic compounds in water. Among them, chlorophenols are considered to be a public health problem due to their carcinogenic properties. Titanium dioxide has proved to be a good catalyst of the degradation of the chlorophenol by photocatalytic oxidation of the target molecule at low concentrations from aqueous medium.

To demonstrate the ability of a semiconductor as a photocatalyst, lab scale systems are designed for testing the semiconductor, where the semiconductor in the form of nanopowders is mixed into the contaminated water to be treated. To be sure that the particles are thoroughly dispersed before entering the photocatalytic reactor, rapid mixing or sonication can be used in addition to mixing the TiO₂ nanoparticles in lowered pH. The suspension then flows though the photocatalytic reactor where it is irradiated with an artificial or natural UV or visible light sources. After the decomposition of the contaminant is completed, the suspension is transferred into a sedimentation basin, and then the nanoparticles are removed from the suspension using filtration. The particles removed from the liquid stream after the photocatalytic reactor can be recycled back into the reactor system. The disadvantage of using nanoparticles is the difficulty in separating the catalyst from the “clean” effluent so it remains behind in the reactor (i.e. packed bed reactor with the catalyst on a support) or to recycle it back into the system (slurry reactor where the catalyst is not on a support). Removal of the catalyst by filtration would require a filter on the order of 10 nm, which would require the capital cost similar to reverse osmosis and nanofiltration. However, for large scale applications, the degradation of the organic compounds cannot be performed in a batch reactor but in a flow-through photocatalytic system.

One viable method for large scale application is immobilizing the semiconductor on a substrate and designing a flow-through reactor to accommodate the contaminant loading. This process design allows for the catalyst to easily be separated from the effluent liquid stream. A packed bed style reactor system such as developed by Borges et al. 2015 for photocatalyst can utilize sun-light. The development of TiO₂ thin film photocatalysts for pollutant removal was motivated by the understanding the photocatalytic activity of nanoparticles embedded in a matrix. Thin film of n-type semiconductor TiO₂ is one of the most outstanding photocatalysts that has been used to decompose model organic pollutants in water, and has received particular attention due to its high chemical stability and photocatalytic activity. TiO₂ has been used in a powder form for photocatalytic degradation of pollutants because a high surface-to volume ratio increases the efficiency of degradation. The latest development of the photocatalyst in the form of a thin film is due to the impractical use of conventional powder photocatalyst in certain environmental applications.

When a transparent support is used, the thin film of TiO₂ can be coated on one side of the transparent support and the film can be illuminated from the backside of the film, but the light can come from the top/front or from the bottom. In this case, the film thickness of semiconductors is thought to be an important factor affecting the performance of the photocatalytic devices. The transparent substrate on which the TiO₂ layer is deposited affect the photocatalytic oxidation activity for water purification. Tada et al (1997) observed a marked difference of the photocatalytic activity between the TiO₂ films coated on quartz and glass substrates, which was interpreted in terms of the difference in the photocarrier's diffusion length induced by impurity Na⁺ions.

Recent developments for improved photocatalytic properties of the metal oxide thin film as well as some environmental applications include film deposition methods, techniques for modifying thin film characteristics, and variation in types of substrates used. There are several methods to obtain films for photocatalytic oxidation of pollutants, which will be discussed briefly.

Blount et al (Blount, Kim et al. 2001) obtained a transparent, thin-film TiO₂ layer prepared by sol-gel deposition with great results for the photocatalytic oxidation of acetaldehyde, acetic acid, and toluene compared to the standard Degussa P25 thin films. Also, because the less-reactive intermediates are slow to form on the sol-gel catalyst, the catalyst deactivates slower during toluene photocatalytic oxidation, which increase the lifetime of the film. Tada et al. (Tada and Tanaka 1997) obtained TiO₂ by sol-gel using a solution of Ti(OiPr)₄ that was stabilized by adding acetyl acetone. The formation of the chelate (Ti(OiPr)₂(acac)₂) resulted in a change in color from pale yellow to red. The concentration of the coating solution was reduced to prepare thinner films. To produce thicker films, the coating procedure was repeated several times. Sopyan et al (Sopyan, Watanabe et al. 1996) obtained semitransparent TiO₂ anatase film with extraordinarily high photocatalytic activity by sintering a TiO₂ sol at 450° C. The kinetics of acetaldehyde degradation as catalyzed by the TiO₂ film were analyzed in terms of the Langmuir-Hinshelwood model. Interestingly, under weak UV illumination intensity and high concentrations of acetaldehyde, the quantum efficiency has exceeded 100% on an absorbed-photon basis, assuming that only photo-generated holes play a major role in the reaction. These results suggested that the photodegradative oxidation of acetaldehyde is not mediated solely by hydroxyl radicals, generated via hole capture by surface hydroxyl ions or water molecules, but also by photocatalytic generated superoxide ion, which can be generated by the reduction of adsorbed oxygen with photogenerated electrons. TiO₂ thin films with uniform macropores were prepared by Kamegawa et al (Kamegawa, Suzuki et al. 2011) using poly(methyl methacrylate) (PMMA) microspheres as a template. The thin films had anatase crystalline structures with relatively high transparency. The incorporation of micropores has significantly enhanced the degradation of organic pollutants such as 2-propanol and acetaldehyde under UV light. It was also found that TiO₂ thin films with macropores exhibited good photoinduced hydrophilicity after a short period of UV light irradiation, and a slow recovery of water contact angles in the dark as compared to those of non-porous TiO₂ thin films.

Chen et al (Chen, Zheng et al. 2017) have deposited TiO₂ films on geopolymer substrates via sol-gel dip coating process. Geopolymers exhibit much better thermal stability than cementitious materials due to their inorganic framework or ceramic-like nature. TiO₂ films with reduced cracking have been obtained from sol precursor with butyl titanate as titanium source and 6% polyvinylpyrrolidone by traditional dip-coating process on geopolymer substrates. It is found that the TiO₂ film exhibits mesoporous morphology. Annealing the TiO₂ film at 600° C. resulted in anatase phase, with high photocatalytic activity to degrading methylene blue.

One of the most heavily investigated 1D nanostructure material such as nanofibers is the metal oxide nanofibers organized in paper-like free standing membranes (PSM) for various applications such as lithium ion batteries, medical devices, high capacity energy storage etc. Photocatalysis was first combined with membrane technology for applications such as separation and reuse of the photocatalyst nanoparticles. Besides developing photocatalytic membranes as standalone parts exhibiting both photocatalytic and separation efficiency, other membranes where the photocatalyst film is fully stabilized on the substrate surface or incorporated in the substrate matrix where developed. Since the photocatalytic membrane reactor approach is very attractive industrial water treatment applications, several methods have been recently developed and optimized for the manufacturing of titania based photocatalytic membranes made of TiO₂ nanofibers through glass filters followed by hot pressing or liquid phase pressurization.

Nanofibers can be produced by electrospinning, which is a process of applying a high voltage to produce an interconnected membrane like web of small fibers with diameters in the nanometer range. This technique has been reported to be successfully utilized in the generation of thin fibers and the fabrication of large surface area membranes from a broad range of polymers, including engineering plastics, biopolymers, conducting polymers, block copolymers and polymer blends. The challenge in electrospinning processes is to control the process parameters to minimize the fiber diameter. Earlier studies have reported the formation of nanofibers with fiber diameters of the order of a few hundreds of nanometers. To date, however, there has been little success in forming ultrafine metal oxide nanofibers such as those having an average diameter of less than 100 microns. U.S. Pat. No. 9,751,818 (2017) presents novel nanowire catalysts that are useful as heterogeneous catalysts in a variety of catalytic reactions, such as the oxidative coupling of methane to C2 hydrocarbons.

Sambandan described in the U.S. Pat. Pat. No. 10,213,780 (2019) the use of multivalence semiconductor photocatalytic materials to enhance photocatalytic activity. These are heterogeneous materials including a p-type semiconductor that contains two metal oxide compounds of the same metal in two different oxidation states and an n-type semiconductor having a deeper valence band than the p-type semiconductor valence bands, wherein the semiconductor types are in ionic communication with each other. The n-type semiconductor can be any suitable semiconductor wherein the charge carriers are electrons, such as electrons in the conduction band which are donated from a donor band of a dopant. The n-type semiconductor can be an oxide of cerium, tungsten, tantalum, tin, zinc, strontium, zirconium, barium, indium, or aluminum oxide, or a combination of them such as: Sn—Ti(O,C,N)₂, SrTiO₃, BaTiO₃, ZrTiO₄, In₂TiO₅, Al₂TiO₅, or LiCa₂Zn₂V₃O₁₂. Al₂₋ₓInₓTiO₅ (0<x<2), Zr_{1-y}Ce_{y}TiO₄ (0<y<1). The n-type semiconductor can be a titanium oxide or multiple phase titanium oxide such as a mixture of anatase and rutile TiO₂ phase. The n-type semiconductor can be a titanium oxide doped with N, C, or both.

U.S. Pat. No. 9,502,711 B2 (2015) presents the fabrication process of biscrolled fiber using carbon nanotube sheet, which converts up to 99 weight percent of one or more functional materials into yarns using twist-based spinning of carbon nanotube sheets. CNT sheets of multiwalled nanotubes (MWNTs), few walled nanotubes (FWNTs), or single walled nanotubes (SWNTs) are used as a platform (providing the mechanical support) for collecting and confining the particle materials, forming a bilayered sheet structure. Then the bilayered sheet ribbon is scrolled into a biscrolled yarn, which is designated the guest@host. The biscrolling method is capable of incorporating large amount of other materials onto CNT sheet, achieving ultra-high loading of the particle materials and maintaining the grain size of the material. As a result, the properties of the biscrolled yarns predominantly come from the deposited guest component other than from CNT sheet. For example, biscrolled yarns have been demonstrated as photocatalysts for self-cleaning textiles.

Diesen et al (2014) have studied the photocatalytic activity of Ag-enhanced TiO₂ films compared to TiO₂ in tris(hydroxymethyl)aminomethane (Tris) aqueous solution under blacklight (365 nm). It was found that the silver in Ag-enhanced TiO₂ film has increased the apparent quantum yield from 7% to 12%, partly as a result of a Schottky barrier formation at the metal-semiconductor interface. Also, as the sensitizing effect of Ag nanoparticles extends the visible light absorption, and enable an efficient charge separation in the TiO₂ through electron transfer processes, Ag nanoparticles attract acceptor species more efficiently than pure TiO₂.

### SUMMARY OF THE INVENTION

Herein disclosed is a photocatalytic flow reactor for improving the photo-efficiency of the photocatalytic oxidative process. Thin photocatalytic baffler arrangements are provided which can be utilized with water treatment devices, such as devices for the photocatalysis. Because the photocatalysis requires time to decompose the pollutants, the present invention introduces photocatalytic baffles in the reaction chamber to improve circulation. The volume, the flow rate and the photocatalytic process dictates the circulation of the liquid in the photocatalytic reaction chamber filled with baffles. The design considerations include the number of baffles, the baffle size (i.e. width, length and thickness) and mounting position. Baffle are mounted at an offset angle to improve turbulence inside the photocatalytic chamber. In another aspect, the invention also relates to thin film catalysts that can be coated or attached to the baffles.

Bafflers have been used in the past in coagulation and flocculation in the water treatment as hydraulic jumps to create turbulence and improve mixing, in-line flash mixing and mechanical mixing. In the present invention, baffles are used as photocatalytic supports on the surface of which the decomposition of the pollutant occurs and to create liquid circulation, so that the pollutant can reach the catalyst bouncing back and forth several times. Also, the agitation created by the flow of liquid through baffles increases the chance of the pollutant to react with the surface of the catalyst. Baffles are an integral part of the photocatalytic reactor design. Baffles are designed to be or to support the catalyst and to direct the fluid for maximum degradation efficiency of the pollutants.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE FIGURES

FIG. 1. Lateral view of the photocatalytic reactor.

FIG. 2. Top view of the photocatalytic chamber.

FIG. 3. Perspective view of the photocatalytic chamber showing the baffler arrangement.

FIG. 4. Side view of the photocatalytic chamber along with the cross-section views A-A and B-B.

FIG. 5. Top view of the photocatalytic chamber showing the direction of the liquid flow.

FIG. 6. Perspective view of the baffler arrangement.

FIG. 7. Top view of the baffler arrangement in the photocatalytic chamber along with the cross section view E-E.

FIG. 8. Front view of the baffler arrangement in the photocatalytic chamber along with the cross section view S-S.

FIG. 9. Top view of the UV light module along with the cross-section M-M.

FIG. 10. Lateral view of the UV light module along with the cross-section X-X.

FIG. 11. Efficiency of the photocatalytic degradation of MB at different initial concentration.

FIG. 12. Efficiency (%) of nano-anatase for MB degradation cycles.

FIG. 13. SEM images of the formation of TiO₂ on the surface of Ti sheets (a) and (b) before photocatalytic activity. The TiO₂ was obtained from Ti sheets by contact with a mixture of 0.1 N NaOH and acetone for 72 hours under ambient conditions.

FIG. 14. Ultraviolet-visible spectra for methylene blue solutions as a function of the irradiation time. Conditions: 1 sheet of TiO₂/Ti was used in the presence of 0.1 mg/L methylene blue.

FIG. 15. Effect of the contact time upon the photocatalytic degradation of methylene blue for concentrations of 0.01, 0.05, 0.1, 0.2, and 0.3 mg/L. Conditions: 2 sheets of TiO₂/Ti were used to treat 100 mL of methylene blue solution using contact times of 15, 30, 45, 60, 90, and 120 min.

FIG. 16. Pseudo-first-order kinetic plot for the degradation of methylene blue by TiO₂/Ti at initial methylene blue concentrations of 0.01, 0.05, 0.1, 0.2, and 0.3 mg/L. Conditions: 2 sheets of TiO₂/Ti were used to treat 100 mL of methylene blue solution for contact times up to 120 min.

FIG. 17. Variation of the pseudo first-order rate constant, k₁, as a function of dye concentration.

FIG. 18. SEM images of the TiO₂ nanoparticles embedded into PLA electrospun nanofibers at various magnifications.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail.

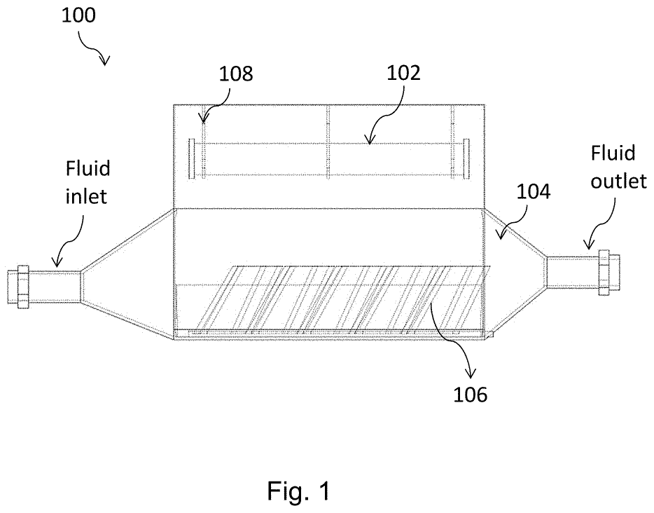

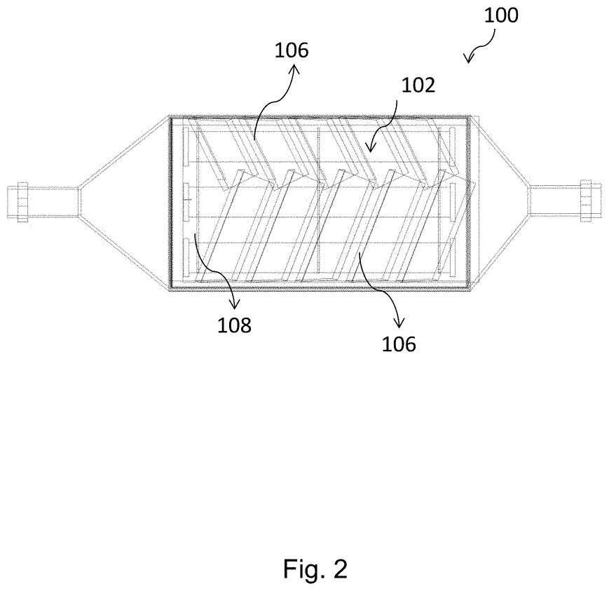

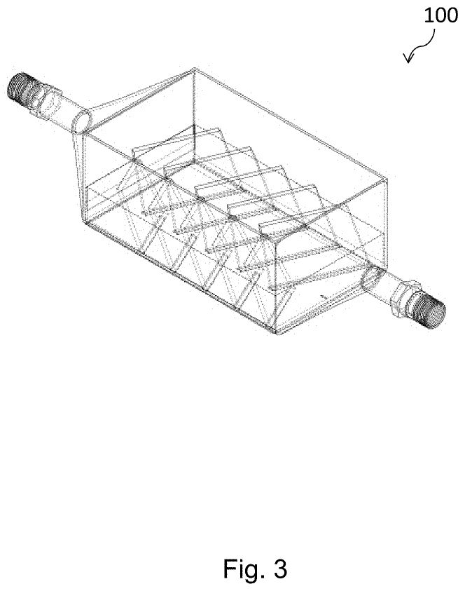

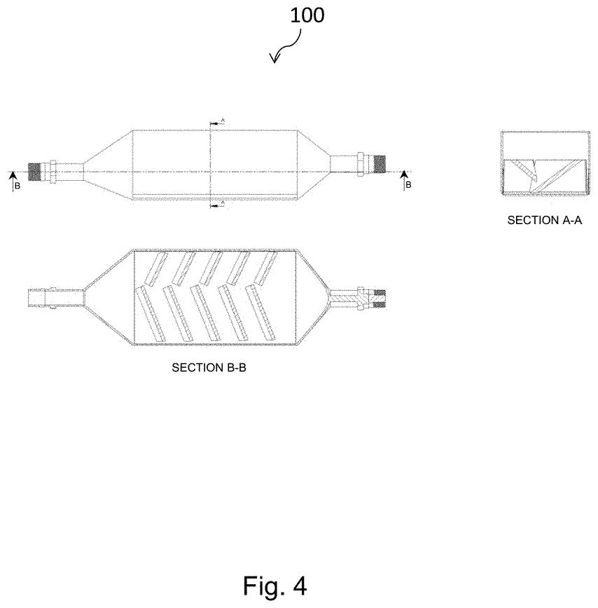

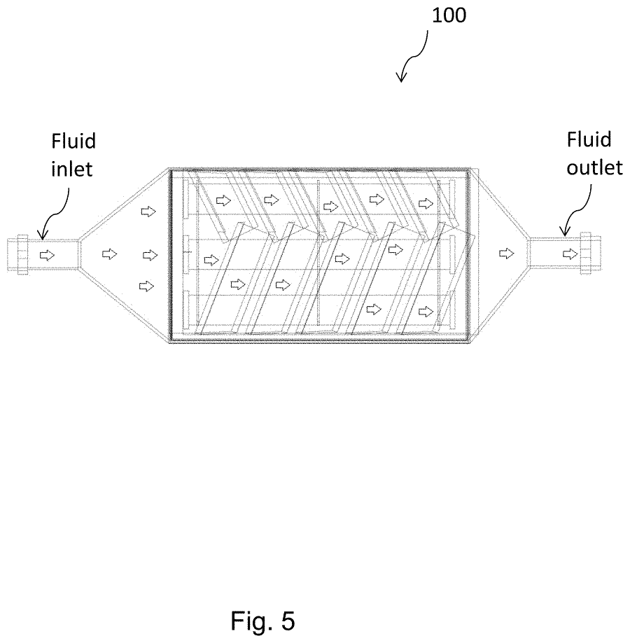

FIG. 1-2 show the lateral and the top views of the photocatalytic reactor 100 consisting of multiple UV lamps 102 and photocatalytic chamber 104. The UV lamps 102 are placed on top of the photocatalytic chamber 104 and hold in place by support elements 108. The photocatalytic chamber contains bafflers 106 coated with a photocatalytic layer. The bafflers 106 may have attached a thin layer of photocatalytic material. FIG. 3 shows a perspective view of the photocatalytic chamber viewing the baffler arrangement through the transparent walls of the chamber. FIG. 4 shows the side view of the photocatalytic chamber along with the cross-section views A-A and B-B. The position of the inlet to the chamber is below the outlet to allow for recirculation of the fluid. FIG. 5 shows the top view of the photocatalytic chamber, where the arrows point the direction of the liquid flow. The flow rate is established so the liquid remains at least 10-60 min in the photocatalytic chamber depending on the pollutants to be degraded. A pump is pushing the liquid through the inlet into the chamber at a constant flow rate.

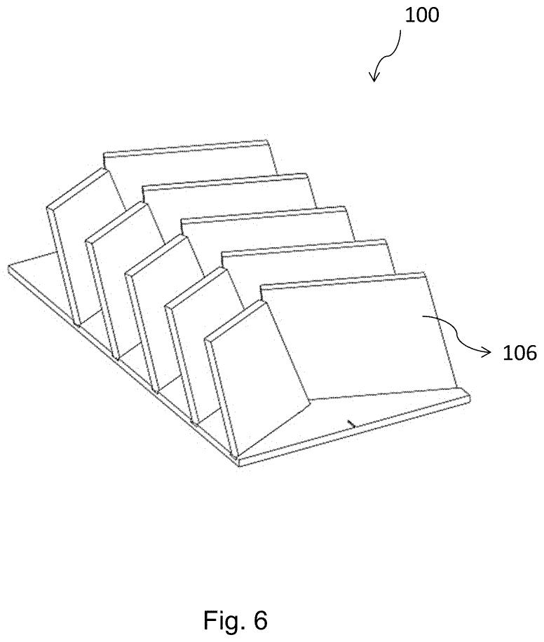

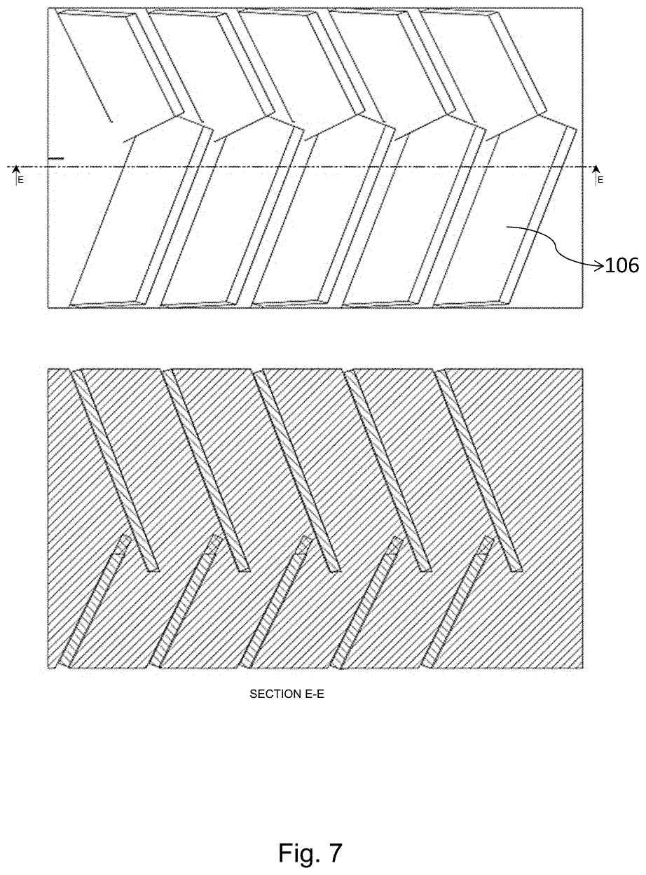

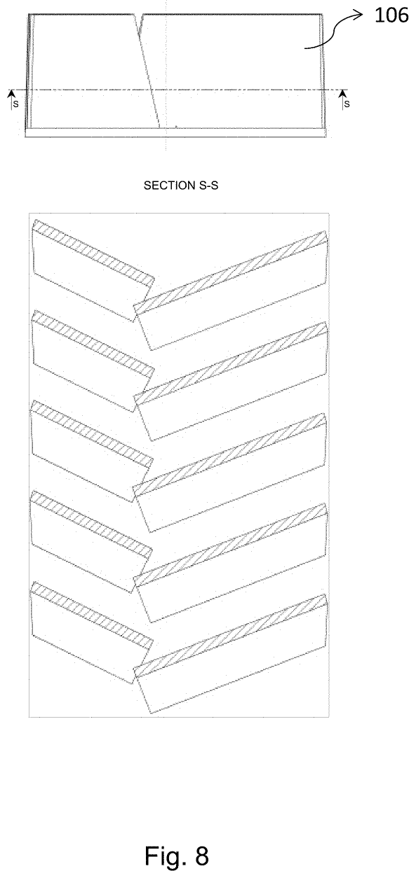

FIG. 6 shows a perspective view of the baffler arrangement in the photocatalytic chamber. The buffers are fixed to the base of the chamber at an angle and arranged in two rows. Buffers in one row are different in width from the bafflers in the other row. FIG. 7 shows a top view of the baffler arrangement in the photocatalytic chamber along with the cross section view E-E. FIG. 8 shows a front view of the baffler arrangement in the photocatalytic chamber along with the cross section view S-S.

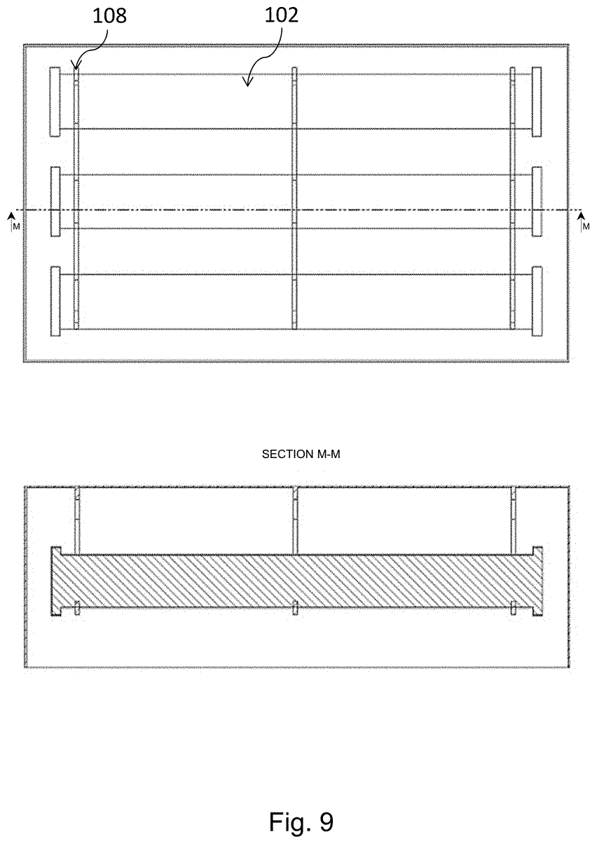

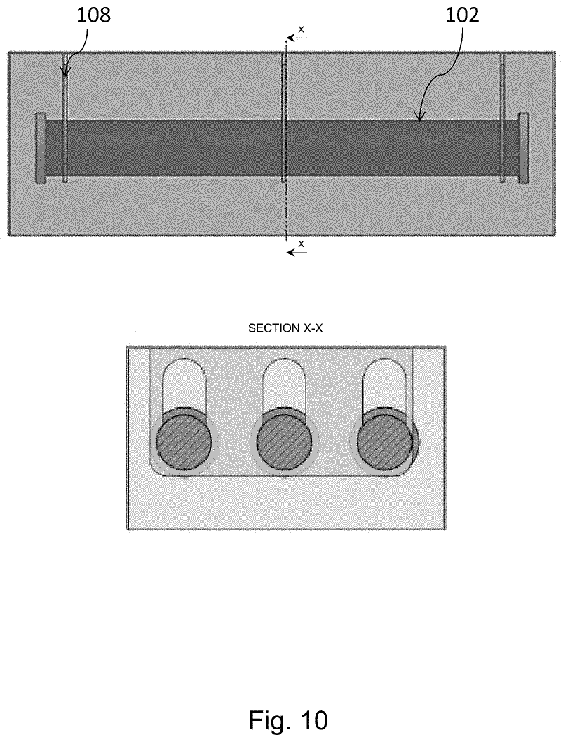

FIG. 9 shows the top view of the UV light module along with the cross-section M-M and FIG. 10 shows the lateral view of the UV light module along with the cross-section X-X. Here there are only 3 UV lights in a module, but more UV lights can be used. Because the photocatalytic chamber has transparent walls, other light sources can be used such as visible light.

On the surface exposed to light source, baffles are coated with photocatalytic material. A number of processes may be used to coat the surface of baffles, including, but not limited to physical deposition, chemical deposition, metallurgical, electrochemical deposition, or combination thereof. On the surface exposed to light source, photocatalytic film can be attached to the surface of baffles. A number of processes may be used to attach catalytic material to baffles, including, but not limited to mechanical, chemical, metallurgical, electrochemical, or combination thereof.

In still other embodiments of the present disclosure, a catalytic material comprising a plurality of catalytic nanoparticles supported on a structured support is provided. For example, the structured support may comprise a nanostructured surface such as etched Ti surface, nanofiber non-woven mat, foam etc.

In certain exemplary embodiments, nanofibers may be combined with microfibers to form an inhomogeneous mixture of fibers. In other exemplary embodiments, a combination of nano and micrometer fibers may be formed as an overlayer on an underlayer comprising the non-woven fibrous web support layer. A number of processes may be used to produce and deposit nanoparticles and nanofibers, including, but not limited to melt blowing, melt spinning, electrospinning, gas jet fibrillation, or combination thereof.

### IMPLEMENTATIONS AND EXAMPLES OF THE INVENTION

Without intent to limit the scope of the invention, exemplary methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example 1

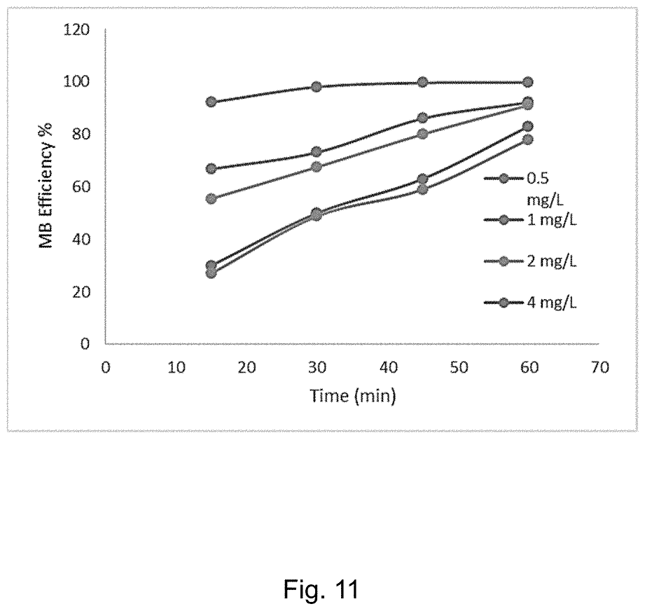

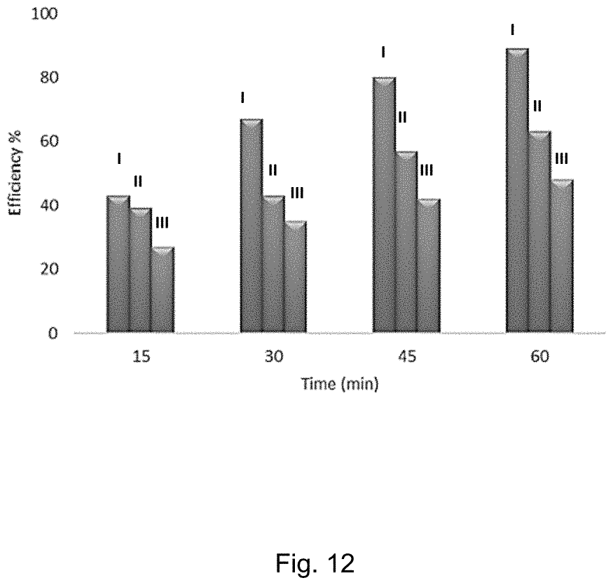

According to the present invention, the photocatalytic degradation of methylene blue (MB) by TiO₂ nanopowder is presented. In this exemplary embodiment, about 5 mL of titanium tetra iso-propoxide (Ti(OCH(CH₃)₂]₄, Sigma-Aldrich, 97%) was added to a mixture of 5 mL acetic acid (CH₃COOH, Sigma-Aldrich) and 50 mL ethanol (C₂H₅OH, Sigma-Aldrich). The mixture was continuous stirred for 30 min; dilute ammonia aqueous solution (1N NH₃, Sigma-Aldrich) was then added to reach the pH 10. The precipitate was washed thoroughly with distilled water and ethanol before dried at 100° C. The powder was calcined at 550° C. for 1 h to improve the crystallinity of the nano-anatase. The photocatalytic activity of nano-anatase was measured based on the reaction rate of the photocatalytic degradation of MB. The results show that the MB efficiency increases with the irradiation time, demonstrating the photocatalytic degradation of MB. FIG. 11, shows that MB efficiency decreases from 99.72 to 78% with increasing the concentrations from 0.5 to 8 mg/L during the 60 min irradiation time. To confirm the photocatalytic stability of the nano-anatase on the degradation of MB, the experiments where repeated tree times consecutively reusing the nano-anatase powder. The stability of the powder was assessed after three cycles of photocatalytic degradation of MB. FIG. 12 shows that the photocatalytic degradation of MB by nano-anatase depends on the contact time. In the first cycle, the photocatalytic degradation of MB increases from 43 to 89% with increasing the contact time from 15 to 60 min, but it drops below 39% in the third cycle at 60 min irradiation time.

### Example 2

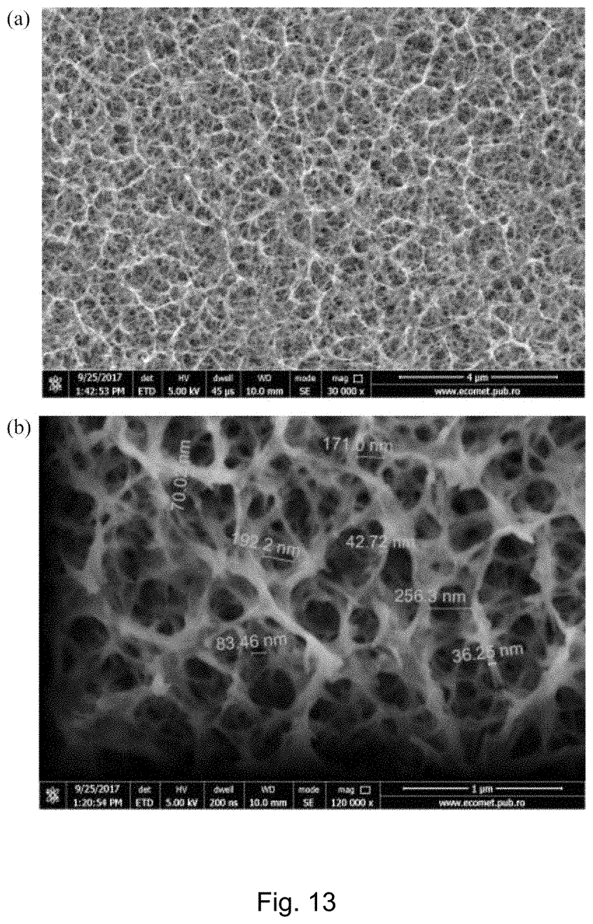

According to the present invention, the photocatalytic degradation of methylene blue (MB) by TiO₂ nanopowder is presented. In this exemplary embodiment, Ti sheets with 2 cm diameter and 3 mm thickness were used. In a typical synthesis, the Ti sheets were chemically polished and treated by sonication with distilled water for 30 minutes to obtain a clean and homogeneous surface. The Ti sheets were subsequently left for 72 hours in a solution of 0.1 N NaOH and acetone at room temperature. The nanostructured Ti sheets were washed with distilled water and dried. X-ray diffraction (XRD) analysis has demonstrated the formation of TiO₂ on Ti sheet. The SEM images presented in FIG. 13 show the formation of TiO₂ on the edges of the pores structure that has an average size distribution from 36 to 356 nm. Photocatalytic activity pf the nanostructured porous surface was investigated on the degradation of methylene blue under four fluorescent tubes served as the source for ultraviolet light with vertical irradiation. Photocatalytic experiments were performed on the degradation of 100 mL aqueous solution of methylene blue using various TiO₂/Ti sheets with different amounts of TiO₂ nanostructures. Prior to irradiation, in order to allow the system to reach equilibrium, the TiO₂/Ti sheets were magnetically stirred for 30 min in the dark and exposed to ultraviolet light. During the irradiation, 5 mL of solution was collected at regular time intervals. The photocatalytic degradation of the MB dye was monitored using an ultraviolet-visible spectrophotometer at 665 nm wavelength. The degradation of the methylene blue solution was evaluated using the following equation:

% Dye Efficiency=(Cₒ−C)/Cₒ×100 (1)

where C is the concentration of methylene blue at a given time (mg/L) and Cₒ is the initial concentration of methylene blue (mg/L).

To characterize the mechanism of photocatalytic degradation of methylene blue using TiO₂/Ti, experimental kinetic measurements were performed by first order kinetics:

1n C/Cₒ=−k₁t (2)

where Cₒ represents the initial the initial concentration of methylene blue (mg/L), C is the concentration of methylene blue at time t (min), and k₁ is the pseudo-first-order rate constant (min⁻¹) and second order kinetics:

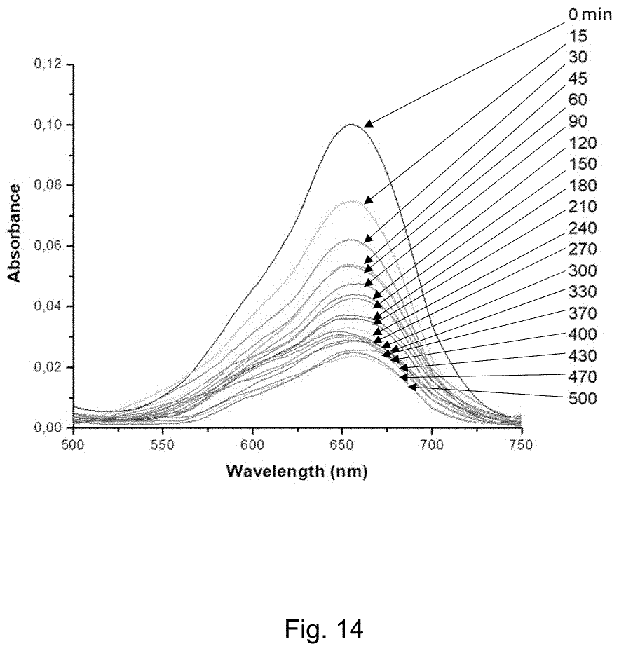

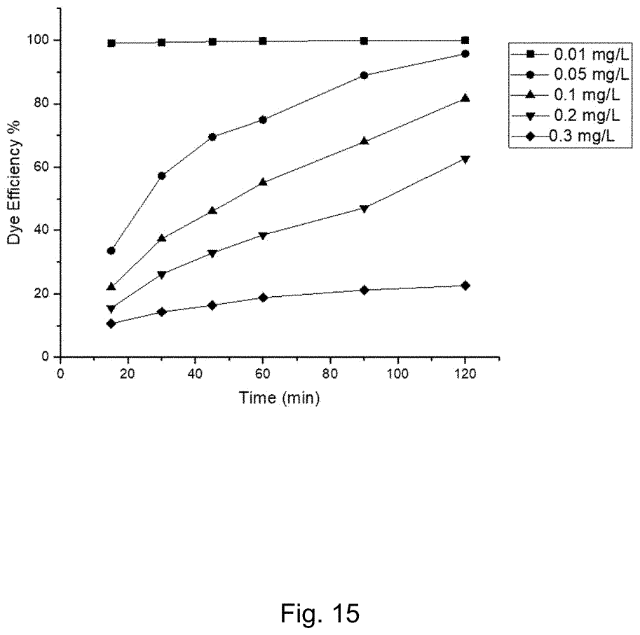

1/C−1/Cₒ=k₂t (3)

where k₂ is the pseudo-second-order rate constant. By plotting (1/C−1/Cₒ) vs t, the pseudo-second-order rate constant (k₂) can be obtained from the slope. The photocatalytic degradation of methylene blue by TiO₂/Ti from the synthetic wastewater solution was evaluated using ultraviolet-visible spectroscopy for a contact time of 8 hours (FIG. 14). The results show that with increasing irradiation time, the absorbed MB at 665 nm decreased, which indicates that the presence of TiO₂/Ti has induced the degradation of the dye. The photocatalytic activity of TiO₂/Ti film was studied by monitoring the degradation of methylene blue by ultraviolet light. To understand the influence of the initial methylene blue concentration on the degradation rate, wastewater solutions containing 0.01, 0.05, 0.1, 0.2, and 0.3 mg/L methylene blue were used for two sheets of TiO₂/Ti. The results show that the highest efficiency was obtained at 99.12% for an initial methylene blue concentration of 0.01 mg/L in the first 15 min irradiation time. With an increase in the methylene blue concentration from 0.01 to 0.3 mg/L, the efficiency decreased from 99.24% to 22.56% at 60 min irradiation time (FIG. 15).

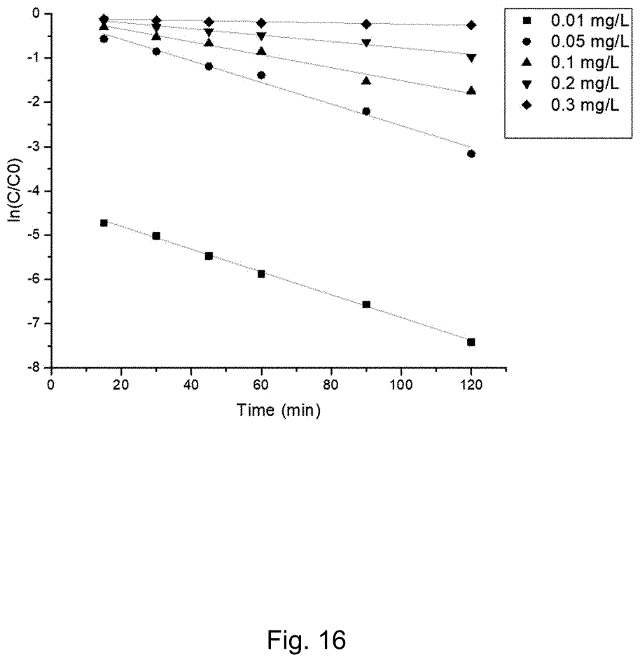

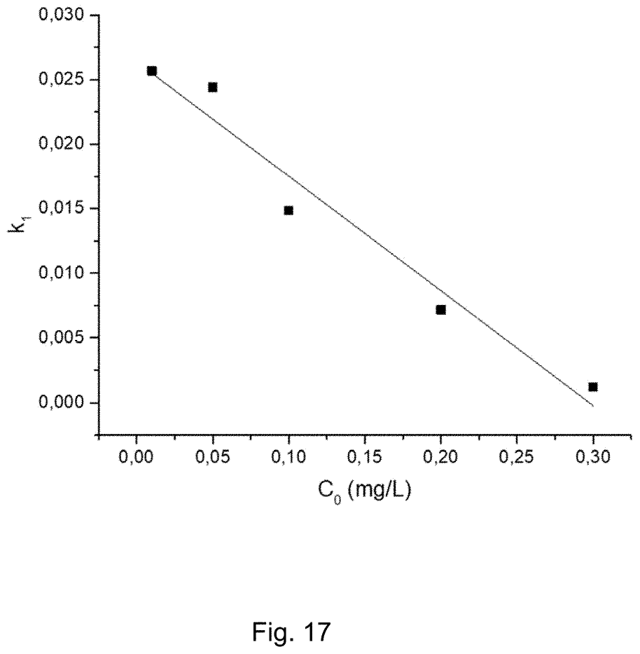

FIG. 16 shows that the photocatalytic degradation of methylene blue follows the pseudo first-order kinetics, which indicates than an increase in dye concentration results in a linear decrease in reaction rate (FIG. 17). The pseudo-first-order kinetic model provided a better fit than pseudo-second-order kinetics for the photocatalytic degradation of methylene blue by the TiO₂/Ti catalyst. The highest value of k₁ was 0.02560 min⁻¹.

### Example 3

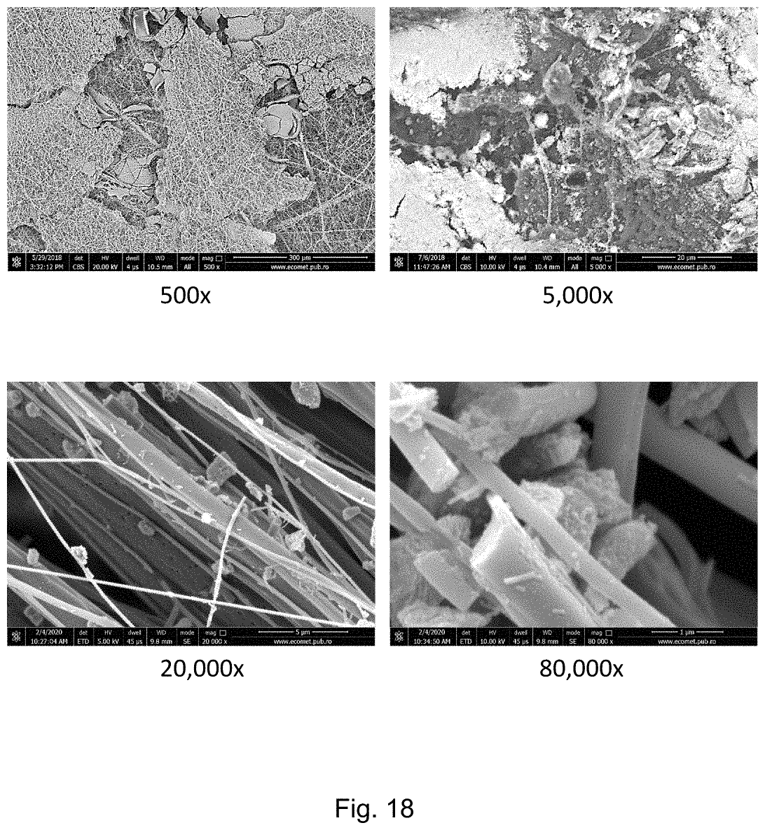

According to another embodiment of the present invention, electrospinning techniques may be used to form nanofibrous non-woven mats to coat the baffler surface exposed to light according to the various embodiments of the present invention as described above. Electrospinning is a method of choice to produce fibers, which uses electric force to draw charged threads of polymer solutions or polymer melts up to fiber diameters in the order of nanometers. The process does not require coagulation or high temperatures to produce solid threads from solution. This makes the process particularly suited to the production of fibers using large and complex molecules. Electrospinning ensures that no solvent can be carried over into the final product. Depending on the size of the collector, large areas of membranes can be obtained. When a sufficiently high voltage is applied to a liquid droplet, the body of the liquid becomes charged, and electrostatic repulsion counteracts the surface tension and the droplet is stretched; at a critical point a stream of liquid erupts from the surface. This point of eruption is known as the Taylor cone. If the molecular cohesion of the liquid is sufficiently high, a charged liquid jet is formed. The size of an electrospun fiber can be in the nano scale and the fibers may possess nano scale surface texture, leading to different modes of interaction with other materials compared with macroscale materials. In addition to this, the ultra-fine fibers produced by electrospinning are expected to have two main properties, a very high surface to volume ratio, and a relatively defect free structure at the molecular level. This first property makes electrospun material suitable for activities requiring a high degree of physical contact, such as providing sites for chemical reactions, or the capture of small sized particulate material by physical entanglement—filtration. The second property should allow electrospun fibers to approach the theoretical maximum strength of the spun material, opening up the possibility of making high mechanical performance composite materials. FIG.18 shows a few SEM images at different magnification as examples of the TiO₂ nanoparticles embedded into a Poly(L-lactide) (PLA) nanofiber non-woven mesh. The PLA nanofibers were obtained from PLA solution obtained by dissolving 10 wt. % in a solvent mixture of 90 wt. % chloroform and 10 wt. % dimethylformamide.

What is claimed is:

1. A flow photocatalytic reactor for degrading pollutants from a liquid in a batch or a continuous process comprising: a plurality of UV sources for photocatalysis; a reaction chamber to photodegrade the pollutants; a plurality of photocatalyst baffles.

2. The apparatus of claim 1 further comprising a number of baffle pads arranged at an angle to each other and to the base.

3. The apparatus of claim 1 further comprising a number of baffle pads arranged in at least two rows.

4. The apparatus of claim 1 further comprising a number of baffle pads arranged in two rows, the baffles in the first row having a length larger than the second row.

5. The apparatus of claim 1 wherein the baffle surface and walls are coated with a porous film containing at least one photocatalytic component.

6. The apparatus of claim 1 wherein the porous photocatalytic film is nanostructured.

7. The apparatus of claim 1 wherein the porous photocatalytic film is attached to the baffler.

8. The apparatus of claim 1 wherein the porous photocatalytic bafflers can be removed, reconditioned and replaced.

9. The apparatus of claim 1 wherein treating the liquid takes place in the photocatalytic chamber where the bafflers creates agitation and recirculation of the passing liquid.

10. The apparatus of claim 1 wherein the transparent walls of the photocatalytic chamber allow for visible light photocatalysis.

11. The apparatus of claim 1, wherein the UV light sources are hung from the ceiling of the chamber and braced by supports.

12. The apparatus of claim 1 wherein the fluid inlet is positioned below the outlet of the fluid from the photocatalytic chamber.

13. The apparatus of claim 1 wherein at least one UV light source located on top of the photocatalytic chamber is positioned in the same direction with the baffler rows.

14. The apparatus of claim 1 wherein the UV light sources are positioned in the proximity of the surface of the catalyst.

15. The apparatus of claim 1 wherein the treatment of water takes place by passing the liquid through the reaction chamber, allowing the necessary time for the pollutant to react with the photocatalyst.

16. The apparatus of claim 1 wherein the photocatalytic reactor has a modular design, wherein the water treatment process taking place simultaneously in multiple photocatalytic reactor.

17. The apparatus of claim 1 wherein the photocatalytic reactor has a modular design, wherein the water treatment process taking place in several stages in a succession of multiple photocatalytic reactor at the same time or at a time.

18. The apparatus of claim 1 wherein the reaction tank has a modular design, wherein the change of the baffle pads occurring individually or simultaneously.
